(19) United States
(12) Patent Application Publication
(10) Pub. No.: US 2007/0075566 A1
(43) Pub. Date: Apr. 5, 2007

(54) Driver's cab for a utility vehicle

(75) Inventors: Ingrid Lindemann, Grafenau (DE); Karl-Heinz Schuller, Aidlingen (DE); Hansjoerg Traub, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/564,809

(22) PCT Filed: Jul. 13, 2004
(86) PCT No.: PCT/EP04/07710

§ 371 Date: Jul. 18, 2006

(30) Foreign Application Priority Data
Jul. 17, 2003 (DE) 103 32 508.5

(51) Int. Cl. B60J 7/00; B62D 33/06

(52) U.S. Cl. 296/190.01; 296/146.1; 180/89.19

(57) ABSTRACT

A driver's cab for a utility vehicle includes a preassemblable door module on at least one side of the vehicle, the door module including a door frame and a door mounted on the door frame; and a supporting structure on which the door is arranged. The supporting structure is prepared for the mounting of the door module. In the mounted state, the door frame is secured on the supporting structure. A driver's cab series, which has a driver's cab for a low-platform vehicle and a driver's cab for a high-platform vehicle, includes a plurality of drivers' cabs having structurally identical supporting structures. At least the driver's cab of the low-platform vehicle includes at least one door module which has a door frame secured on the supporting structure and a vehicle door fastened to the door frame.

### BACKGROUND AND SUMMARY OF THE INVENTION

The invention relates to a driver's cab for a utility vehicle with a supporting structure and to a driver's cab series with a driver's cab for a low-platform vehicle and with a driver's cab for a high-platform vehicle.

EP 0 646 517 B1 discloses driver's cab series of modular construction with drivers' cabs of differing lengths and heights and of different roof attachments. A driver's cab front wall and a driver's cab rear wall are designed as identical parts, and the side walls differ in height. In order to optimize the drivers' cabs in terms of outlay on manufacturing and installation, height-variable driver's cab doors of modular construction are proposed. The driver's cab series have a basic door in their lowest embodiment. For all higher designs, a basic door is provided with a door top part which is adapted to the upper frame part of the basic door and is designed as a plug-in frame part. The door top parts may differ in height and therefore cover the requirement for different driver's cab doors or drivers' cabs.

DE 689 05 013 T2 discloses a series of cabs of different dimensions and, in particular, of different overall heights for heavy motor vehicles. The cabs have a vehicle driver's compartment with two lateral panels which each comprise a closed frame, a door, a front panel and a rear panel. In this case, the height of the vehicle driver's compartment is the same for all cabs of the series whereas the height of the panels differs for different cabs of the series, thus obtaining cabs of different overall heights by combining cabs of constant height and panels of differing height.

EP 0 029 880 B1 discloses a truck with a chassis comprising a frame and axles and with a driver's cab which is arranged thereon. The cab comprises a cab base and a cab upper part which is releasable therefrom. In this case, the cab base is adapted to the chassis and has all of the units supported on the floor. The standardized cab upper part is secured on the cab base by means of an intermediate coupling part which has securing points for different designs of cab bases. It is therefore possible, even in the case of differing chassis, always to use structurally identical cab upper parts and merely to adapt the cab base to the particular special embodiment of the chassis. Differing chassis may be the results of for example, different axle bearings, wheel sizes or other different intended purposes of the vehicle.

The present invention is concerned with the problem of specifying, for a driver's cab, an improved embodiment which, in particular, makes it possible in a simple manner to design drivers' cabs with an identical supporting structure as a low-platform or as a high-platform vehicle and thus to make possible an inexpensive formation of variants.

This object is achieved by the invention as described and claimed below.

The invention is based on the general concept, in the case of a driver's cab for a utility vehicle, which has a supporting structure on which a door mounted on a door frame is arranged on each side of the vehicle, and a door module which is preassemblable from the door and the door frame. The supporting structure is prepared for the mounting of this door module, and the door frame, in the mounted state, is secured on the supporting structure. This provides the advantage that different variants of drivers' cabs, for example for low-platform vehicles or for high-platform vehicles, can be achieved in a simple manner by changing the door module without changing the supporting structure of the driver's cab. For the manufacturing process, this means that only a single supporting structure has to be kept in stock for very different drivers' cabs or particular driver's cab series, and the formation of variants of the drivers' cabs can be achieved by arranging individual door modules on the supporting structure. The reduction in the different components to be kept in stock contributes substantially to a reduction in the costs on logistics, storage and manufacturing.

According to a preferred embodiment according to the invention, in the region of the door module the supporting structure can have a supporting frame to/into which the door frame is fitted/inserted and to which the door frame is secured. In this case, the supporting frame can be designed for receiving different doorframes. As a result, for the purpose of a rapid and flexible possibility of varying the type, a cost-effective production and installation of different drivers' cabs can be achieved by using a standard or structurally identical supporting structure with a supporting frame and different door modules adapted to the particular intended use. At the same time, a consistently identical installation operation is achieved even in the case of different door modules by using the standard or structurally identical supporting structure, thus ensuring a rationalized and cost-effective production process of the drivers' cabs.

The door module can expediently be designed so that it makes a low entrance to the driver's cab possible, said entrance can be used for a low-platform vehicle. Even drivers' cabs for low-platform vehicles with a particularly low entrance can be produced from the preassemblable door module and the standard supporting structure of the driver's cab, so that even special vehicles, such as vehicles for the package delivery service, can be realized without large changes during the installation operation of the driver's cab.

According to a favorable development, if the door module is absent and in the case of a high-platform vehicle, the supporting frame is designed to serve as a frame for a different door which is fastened to it and is shorter than the vehicle door of the door module. This means that, by mounting a different door, any desired high-platform vehicle can be realized whereas a low-platform vehicle can be realized in a simple manner by the door module mounted on the supporting frame.

It may expediently be provided that the respectively different door modules have a closed appearance together with the driver's cab. In particular from points of view concerned with design, it is of great importance for the driver's cab, which constitute the main design element in particular in the case of trucks, appears aesthetically and visually satisfactory.

It goes without saying that the features mentioned above and those which have yet to be explained below can be used not only in the respectively stated combination but also in different combinations or on their own without departing from the scope of the present invention.

Preferred exemplary embodiments of the invention are illustrated in the drawings and are explained in more detail in the descriptions below, with reference numbers referring to identical or similar or functionally identical components.

### BRIEF DESCRIPTION OF THE DRAWINGS

FIG. 1 shows a perspective view of a driver's cab according to the invention with an inserted door module, and

FIG. 2 shows a view as in FIG. 1 but without an inserted door module.

### DETAILED DESCRIPTION OF THE DRAWINGS

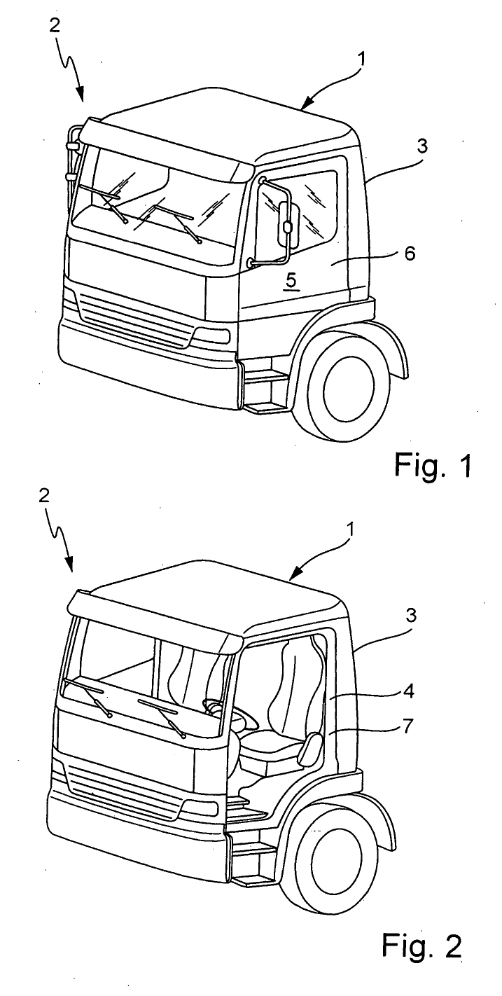

According to FIG. 1, a utility vehicle 2 has a driver's cab 1 according to the invention with a supporting structure 3 on which a door 5 mounted on a door frame 4 is arranged on each side of the vehicle. By way of example, according to FIG. 1 and FIG. 2, the utility vehicle 2 is illustrated as a tractor but in principle a design as a transporter, for example for a delivery service, is also conceivable.

The door frame 4 and the door 5 form a preassemblable door module 6 on at least one side of the utility vehicle 2. In this case, the supporting structure 3 of the driver's cab 1 is prepared for the mounting of the door module 6 and, with the door module 6 mounted, secures the door frame 4. In general, this means that a driver's cab 1 which is always identical for certain series or certain types of vehicles is used with an identical supporting structure 3. The driver's cab 1 is varied by mounting a door module 6 adapted to the particular intended use of the utility vehicle 2. This affords the advantage in particular that, for different types of vehicle or driver's cab series, use can be made of basic bodies or supporting structures 3 which are always identical and on which different door modules 6 can be arranged in order to specify the intended use.

In the region of the door module 6, the supporting structure 3 has a supporting frame 7 to/into which the door frame 4 is fitted/inserted and on which the door frame 4 is secured. The preassemblable door module 6, which comprises the door frame 4 and the particular door 5, can therefore be secured on the supporting frame 7 prepared for it. This contributes to rapid and flexible type changes and a cost-effective production and installation of different drivers' cabs 1 by using a standard or structurally identical supporting structure 3 with a supporting frame 7 and different door modules 6 adapted to the particular intended use.

Furthermore, the door module 6 can be designed so that it makes a low entrance to the driver's cab 1 possible. The entrance is being usable for a low-platform vehicle. The low entrance is ensured by the vehicle door 5 of the door module 6 being of generally longer design than would be the case for a normal high-platform vehicle. If the door module 6 is absent and in the case of a high-platform vehicle, in the case of one preferred variant, the supporting frame 7 can then be designed in such a manner that it serves as a frame for a different door (not illustrated) which can be fastened to it and is shorter than the vehicle door 5 of the door module 6.

In addition, driver's cab series with a driver's cab 1 for a low-platform vehicle and with a driver's cab 1 for a high-platform vehicle can be realized by the invention. The drivers' cabs 1 likewise have structurally identical supporting structures 3, and at least the driver's cab 1 of the low-platform vehicle is equipped with at least one door module 6 which has a door frame 4 secured on the supporting structure 3 and a vehicle door 5 fastened to it. In this case, it may be expedient for the driver's cab 1 of a low-platform vehicle to mount the driver's cab 1 on an undercarriage of the vehicle in a manner such that it is offset forward and downward in the direction of travel in comparison to a driver's cab 1 of a high-platform vehicle.

The embodiments and advantages of the invention can be transferred analogously from the driver's cab 1 described to the driver's cab series.

Both for the drivers' cabs 1 and for the driver's cab series, the different door modules 6 can in each case have no curvature (for example in the case of a folding door or trapdoor) or can have a curvature differing in extent (for example in the case of a rotary or sliding door). The invention is therefore not only suitable for doors 5 and door modules 6 with an identical curvature but also with a different curvature, the respectively different door modules 6 having a closed appearance together with the supporting structure 3. This is of great importance in particular for design, since the driver's cab 1 constitutes the main design element in the case of utility vehicles 2. The driver's cab may also have a different curvature on its side door.

In summary, the essential features of the invention can be characterized as follows:

The invention envisages, in the case of a driver's cab 1 for a utility vehicle 2, forming a door module 6 which is preassemblable from the door 5 and the door frame 4, the supporting structure 3 of the driver's cab 1 being prepared for the mounting of this door module 6 and the door frame 4, in the mounted state, being secured on the supporting structure 3.

This affords the advantage that different variants of drivers' cabs 1, for example for low-platform or for high-platform vehicles, can be achieved in a simple manner by changing the door module 6 without the supporting structure 3 of the driver's cab 1 having to be changed. As a result, only a single supporting structure 3 for the very different drivers' cabs 1 or particular driver's cab series having to be kept in stock. This contributes substantially to reducing the costs on logistics, storage and manufacturing.

1-13. (canceled)

14. A driver's cab for a utility vehicle, comprising:
a preassemblable door module on at least one side of the vehicle, the door module including a door frame and a door mounted on the door frame;
a supporting structure on which the door is arranged, wherein the supporting structure is prepared for the mounting of the door module, and wherein in the mounted state, the door frame is secured on the supporting structure.

15. The driver's cab as claimed in claim 14, wherein in a region of the door module the supporting structure includes a supporting frame to which the door frame is securely fitted or into which the door frame is securely inserted.

16. The driver's cab as claimed in claim 15, wherein the door module is designed so that it makes a low entrance to the driver's cab possible, said entrance being usable for a low-platform vehicle.

17. The driver's cab as claimed in claim 16, wherein if the door module is absent and in the case of a high-platform vehicle, the supporting frame is a frame for another door which is fastened to the frame and is shorter than the vehicle door of the door module.

18. The driver's cab as claimed in claim 17, wherein the door of the door module is designed as a folding door.

19. The driver's cab as claimed in claim 18, wherein the driver's cab is designed for a subsequent changing-over to a different door module, and/or wherein the door module is designed for a subsequent changing-over to a different door.

20. The driver's cab as claimed in claim 14, wherein the door module is designed so that it makes a low entrance to the driver's cab possible, said entrance being usable for a low-platform vehicle.

21. The driver's cab as claimed in claim 15, wherein if the door module is absent and in the case of a high-platform vehicle, the supporting frame is a frame for another door which is fastened to the frame and is shorter than the vehicle door of the door module.

22. The driver's cab as claimed in claim 14, wherein the door of the door module is designed as a folding door.

23. The driver's cab as claimed in claim 14, wherein the driver's cab is designed for a subsequent changing-over to a different door module, and/or wherein the door module is designed for a subsequent changing-over to a different door.

24. A driver's cab series with a driver's cab for a low-platform vehicle and with a driver's cab for a high-platform vehicle, comprising:
a plurality of drivers' cabs having structurally identical supporting structures, wherein at least the driver's cab of the low-platform vehicle includes at least one door module which has a door frame secured on the supporting structure and a vehicle door fastened to the door frame.

25. The driver's cab series as claimed in claim 24, wherein in a region of the door module the supporting structure includes a supporting frame to which the door frame is securely fitted or into which the door frame is securely inserted.

26. The driver's cab series as claimed in claim 25, wherein the door module is designed so that it makes a low entrance to the driver's cab possible, said entrance being usable for a low-platform vehicle.

27. The driver's cab series as claimed in claim 26, wherein the different door modules each have a curvature differing in extent or do not have a curvature.

28. The driver's cab series as claimed in claim 27, wherein the respectively different door modules have a closed appearance together with the supporting structure.

29. The driver's cab series as claimed in claim 28, wherein the door of the door module is designed as a folding door.

30. The driver's cab series as claimed in claim 29, wherein the driver's cab is designed for a subsequent changing-over to a different door module, and/or wherein the door module is designed for a subsequent changing-over to a different door.

31. The driver's cab series as claimed in claim 24, wherein the door module is designed so that it makes a low entrance to the driver's cab possible, said entrance being usable for a low-platform vehicle.

32. The driver's cab series as claimed in claim 24, wherein the different door modules each have a curvature differing in extent or do not have a curvature.

33. The driver's cab series as claimed in claim 24, wherein the respectively different door modules have a closed appearance together with the supporting structure.

34. The driver's cab series as claimed in claim 24, wherein the door of the door module is designed as a folding door.

35. The driver's cab series as claimed in claim 24, wherein the driver's cab is designed for a subsequent changing-over to a different door module, and/or wherein the door module is designed for a subsequent changing-over to a different door.
